(19) United States
(12) Patent Application Publication
(10) Pub. No.: US 2007/0005691 A1
(43) Pub. Date: Jan. 4, 2007

(54) Media conference enhancements

(76) Inventor: Vinodh Pushparaj, Santa Clara, CA (US)

Correspondence Address: MARGER JOHNSON & MCCOLLOM, P.C., 210 SW MORRISON STREET, SUITE 400, PORTLAND, OR, 97204, US

(21) Appl. No.: 11/139,895

(22) Filed: May 26, 2005

(51) Int. Cl. G06F 15/16

(52) U.S. Cl. 709/204

(57) ABSTRACT

An embodiment may be a method comprising recording a portion of a conference, and sending a copy of the recorded portion of the conference to a recipient with at least one of a voicemail account and an email account. Another example embodiment may be an apparatus comprising a means for sending meeting information to an attendee of the meeting before the meeting, a means for receiving an answer from the attendee in at least one of a voice mail format and an email format, and a means for other participants of the meeting reviewing the answer before the meeting.

### BACKGROUND

Conferencing tools allow real-time meetings between physically remote parties. Conferencing has migrated from circuit switched communications networks onto packet switched data networks as well as combinations of different types of networks.

With the advent of a phone conference, more than two people were allowed to be physically remote but still actively participate in a meeting. The development of computer networks and their subsequent merging with the communications and entertainment infrastructures, allowed conferencing over more networks at a considerably lower cost.

Conferences typically involve three or more people, but may have a few key participants and knowledge sources unable to participate. In these situations, the time of the available participants may be unproductively used.

Many conference solutions come with an associated web interface to enhance productivity. Some solutions provide the capability to record meeting comments to an in-session conference. Likewise, rich media conferences provide productivity enhancement. Rich media is generally digital content that can be dynamically displayed, such as a video stream, captions, or a slide presentation.

Even with these solutions the combined conference infrastructure is under utilized. These shortcomings may be improved.

### SUMMARY

Embodiments may provide added functionality to conferencing solutions to allow pre-meeting consultations, in-meeting knowledge gathering breakout or post-meeting task follow-up mechanisms. Some embodiments may integrate these functions with email or voicemail. Some embodiments may integrate voice, video and web conferencing capabilities with either email or voicemail.

An embodiment may be a method comprising recording a portion of a conference, and sending a copy of the recorded portion of the conference to a recipient or a non-attending participant with at least one of a voicemail account and an email account.

In an embodiment a method may comprise sending meeting information to an attendee of the meeting before the meeting, receiving an answer from the attendee in at least one of a voice mail format and an email format, and other participants of the meeting reviewing the answer before the meeting.

An embodiment may be an apparatus comprising a means for recording a portion of a conference, and a means for sending a copy of the recorded portion of the conference to a recipient or a non-attending participant with at least one of a voicemail account and an email account.

Another example embodiment may be an apparatus comprising a means for sending meeting information regarding a meeting to an attendee of the meeting before the meeting, a means for receiving an answer from the attendee in at least one of a voice mail format and an email format, and a means for other participants of the meeting reviewing the answer before the meeting.

In yet another example embodiment, an article of machine-readable medium may contain instructions that, when executed, cause a machine to record a portion of a conference, and send a copy of the recorded portion of the conference to a recipient or a non-attending participant with at least one of a voicemail account and an email account.

### BRIEF DESCRIPTION OF THE DRAWINGS

Embodiments of the invention may be best understood by reading the disclosure with reference to the drawings, wherein:

FIG. 1 illustrates an embodiment method providing a set of enhancements to rich media conferences.

FIG. 2 illustrates an embodiment method providing a set of enhancements to rich media conferences.

FIG. 3 illustrates an apparatus machine to execute instructions that may be contained on a machine readable medium and may provide a set of enhancements to rich media conferences.

### DETAILED DESCRIPTION

In the following description, numerous specific details are set forth. However, it is understood that embodiments of the inventions may be practiced without these specific details. In other instances, well-known circuits, structures, and techniques have not been shown in detail in order to not obscure the understanding of this description.

Reference in the specification to “one embodiment” or “an embodiment”, etc., means that a particular feature, structure, or characteristic described in connection with the embodiment is included in at least one aspect of the invention. The appearances of the phrase “in one embodiment” in various places in the specification do not necessarily all refer to the same embodiment.

Generally, embodiments may provide added functionality to conferencing solutions to allow pre-meeting consultations, in-meeting knowledge gathering breakout or post-meeting task follow-up mechanisms. This functionality may be sent to meeting and conference attendees, scheduled participants, non-attending participants, to a recipient not previously associated with the meeting, or any other person that may contribute to the meeting. Some embodiments may integrate these functions with email or voicemail. Some embodiments may integrate voice, video and web conferencing capabilities. These features enhance overall productivity for meetings.

Embodiments may be integrated directly into private voice and data networks and enterprise applications. Embodiments may provide added functionality to conferencing solutions and overlay or interface with existing calendar or scheduling programs. Additionally, embodiments may be provided for users or for administrators, in a software example, embodiments may provide a software module for a desktop client as well as server software. Generally, embodiments are not limited to either users or managers, but may provide functionality at all levels of a network. Furthermore, embodiments may interface with a platform manager and integrate with login, conference setup, and conference join functionality.

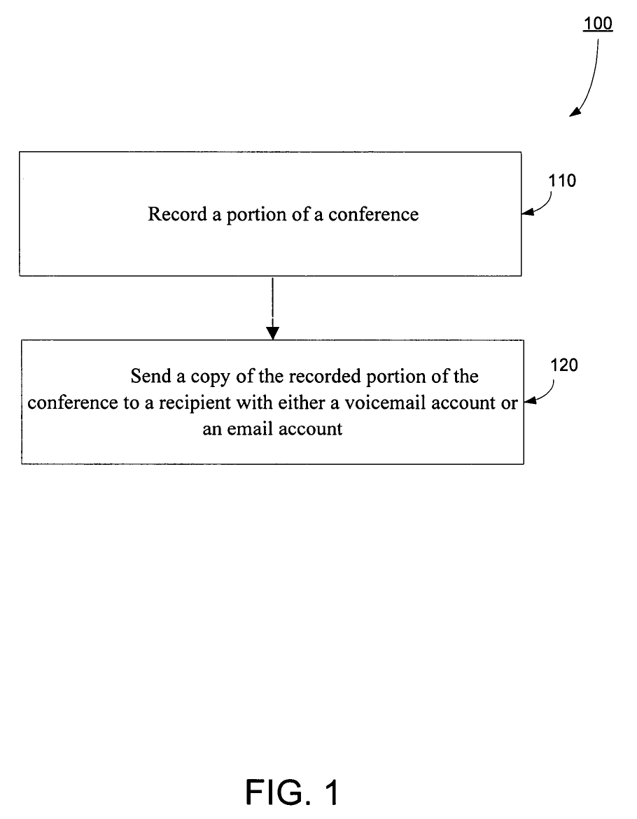

FIG. 1 illustrates an embodiment method 100 providing a set of conference enhancements. An embodiment method may provide a set of enhancements for a rich media conference. An embodiment method 100 may include recording a portion of a conference as illustrated in block 110. The embodiment method 100 may also send a copy of the recorded portion of the conference to a recipient or a non-attending participant with either a voicemail account or an email account, as illustrated in block 120.

An embodiment may comprise receiving a response from the recipient or a non-attending participant of the recorded portion and providing it to the conference attendees. In one embodiment, the recorded portion may relate to a task the recipient or a non-attending participant received during the meeting. Yet another embodiment may further comprise showing a status of the task and recording follow up actions by the recipient or a non-attending participant. An embodiment may comprise integrating the task status and follow up actions by the recipient or a non-attending participant into conference software. Yet another embodiment may comprise notifying conference attendees when a task is completed.

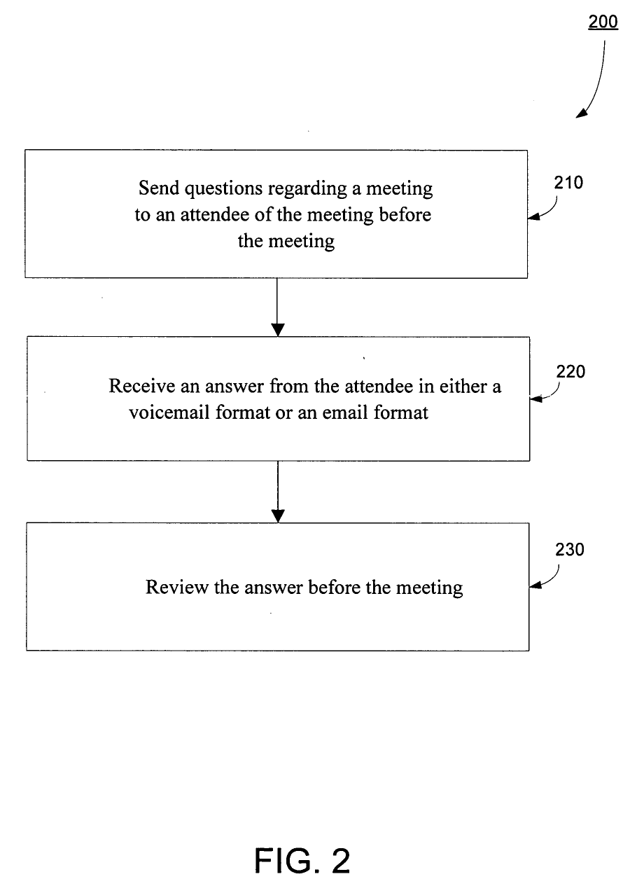

FIG. 2 illustrates an embodiment method 200 providing a set of enhancements to rich media conferences. An embodiment method may provide a set of enhancements for a rich media conference. An embodiment method 200 may include sending meeting information, such as questions, a meeting agenda or any other information useful to the meeting or any participant of the meeting, to an attendee of the meeting before the meeting as in block 210. The embodiment method 200 may also provide an answer in at least one of a voicemail or an email format as illustrated in block 220. Additionally, the embodiment method 200 may include reviewing the answer in block 220 before the meeting as illustrated in block 230.

Embodiments may also provide pre-meeting consultations, in-meeting knowledge gathering breakout or post-meeting task follow-up mechanisms. Furthermore, the three proposed mechanisms may be used independent of each other, or may be integrated with email or voicemail.

A pre-meeting consultation embodiment allows meetings with more informed attendees. Meetings often require a certain amount of time to get people on the ‘same page’. Unfortunately, the schedule of each meeting attendee may be inflexible. In an embodiment, a moderator may send meeting information, for example a list of questions/agenda items, to at least some of the meeting participants to consider or comment on prior to the meeting. An embodiment may provide a mechanism for participants to respond or express their views in a dialogue with other parties irrespective of whether they can attend the meeting. An embodiment may record this dialogue and make it available to other meeting attendees or others who may need access to the development of the topic of the meeting.

In an embodiment, a meeting invitation may contain a web link, a connection, or a web dial link to relevant pre-meeting information. An embodiment may allow access to meeting information, such as a questionnaire or to an agenda items listing to be responded to, as examples. In an embodiment the reply may be with a voice, a video, or a text recording.

In these embodiments, meeting participants may go through an agenda with recorded messages of other participants prior to the meeting, allowing a more fruitful meeting. An embodiment may allow a moderator to play the responses to meeting attendees or other included parties. As an example, for recorded text a text to speech (TTS) engine could play the text to phone participants of the meeting.

A pre-meeting consultation embodiment allows each meeting participant, or other included party, to more fully consider meeting topics and therefore promote a more productive meeting. In an embodiment, a pre-meeting consultation may be integrated into a calendar or scheduling program or device.

In yet another embodiment, at least some of the pre-meeting consultation information may be dispensed to expected meeting attendees or other interested parties. Example mechanisms to dispense pre-meeting consultation information include email, voicemail and the like. Therefore embodiments allow interested parties to become aware of other interested parties views and considerations and ideally provide better information management and more productive meetings. An embodiment may provide a post-meeting comment session to hear what each participant got out of the meeting. An embodiment may provide multipart responses where questions or agenda items can be coupled with responses from each participant.

The functionality of the disclosed embodiments, and all other embodiments, may be integrated with conventional meeting software and hardware, for example, it may include in-session comments as added by attendees during a meeting. Furthermore, an embodiment may be a web based or VXML interface, allowing a central forum for interested parties to access.

An embodiment may provide in-meeting breakouts. Conventional in-session recording of meetings leaves out valuable commentary by other interested parties. For example, scheduled attendees who do not make the meeting, or commentary offered by other non-attending contributors would not be recorded in meeting notes in prior art approaches. Embodiments provide a way to capture input from all interested parties and also may provide a forum for all interested parties to access and comment on the information in the forum.

An embodiment may provide a mechanism to capture a portion of the meeting and make it available to attending and non-attending parties. A capture mechanism may be provided in a web interface that provides functionality to capture the current conference session in total or in part. This embodiment would allow starting and stopping recording of the session and further may provide access to this recorded portion to attending and non-attending parties.

An embodiment may further allow participants to contribute to meeting information, such as a question or comments during a breakout. An embodiment may further allow these contributions to be passed on to a person or group for their answers or comments. In an embodiment, a moderator may dispense this information to interested parties. For example, a moderator may dispense this information by sending a voice mail message or an email or email attachment and may further include a link for the recipient or a non-attending participant to respond to. This functionality may be provided with a unified messaging product, as an example.

In an embodiment, if a person responds to a question during a conference, a moderator has the option to play the response to the question immediately or attach the response to a meeting recording for post-meeting review. In an embodiment, the moderator may play the response to all the participants in the conference.

In contrast to a conventional conference where attendees can instant message (IM) or call outside parties during the conference, an embodiment mechanism allows interested parties to send meeting information such as a question with help from all meeting participants and allows the recipients or a non-attending participants to answer at their convenience. An embodiment allows the responses and questions to be embedded in the meeting minutes for access by any interested party at any time.

The present embodiment is further in contrast with conventional breakout sessions where a separate media channel is created, that is, the present embodiment may reuse part of a conference session to send conference content to other interested parties.

An embodiment may provide post meeting task follow-ups. In almost all meetings people go out with assigned tasks, or action items (AI), to ask others about specific questions or to find an answer to some questions. Although follow-up emails are a powerful tool to do this, voice recordings will provide an enhanced experience. Embodiments may therefore add email or voice recording functionality with an integrated follow-up mechanism to a conference system. In an embodiment these post meeting task follow-ups may serve as a pre-meeting consultation for a subsequent meeting.

An embodiment may provide an automated AI submission and follow-up tool for a conferencing solution. Similar to the in-meeting breakout embodiments, an embodiment may provide a mechanism to capture a portion of the meeting and send it to the person responsible for the AI. A capture mechanism may be provided in a web interface that provides functionality to capture the current conference session in total or in part.

This embodiment would allow starting and stopping recording of the session and further may provide access to this recorded portion to attending and non-attending parties. An embodiment may send a voicemail or an email with a description of the AI to the AI owner. An AI owner may then use the web interface to respond to the AI perhaps to update status or record follow-up actions.

In an embodiment, meeting participants may be notified about the completion of actions items and the responses can be accessed through a web interface. By combining these with meeting recordings, meeting participants may understand the context of a particular AI, as well as become aware of AI follow-ups. Furthermore, an embodiment may provide post meeting task follow-up functionality in a central location.

A post meeting action items follow-up embodiment is an enhancement to conventional mechanisms of leaving comments at the end of meetings. For example, the present embodiment allows notification about AI and subsequent follow-up recordings.

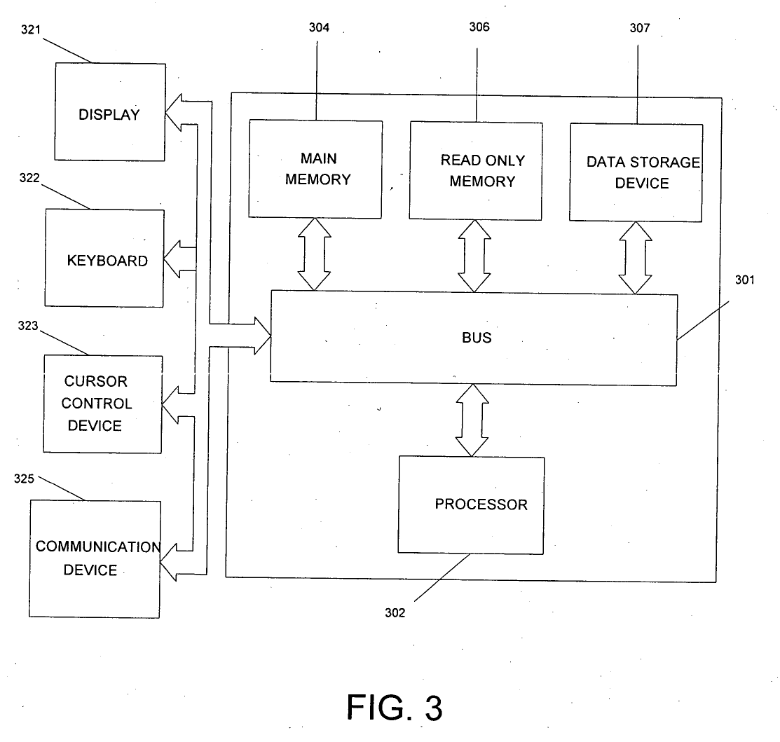

FIG. 3 illustrates an apparatus machine to execute instructions that may be contained on a machine readable medium and may provide a set of conference enhancements.

Embodiments of the invention are not limited to a single computing environment. Moreover, the architecture and functionality of embodiments as taught herein and as would be understood by one skilled in the art is extensible to other types of computing environments and embodiments in keeping with the scope and spirit of the invention. The invention provides for various methods, computer-readable mediums containing computer-executable instructions, and apparatus. With this in mind, the embodiments discussed herein should not be taken as limiting the scope of the invention; rather, the invention contemplates all embodiments as may come within the scope of the appended claims.

Embodiments of the present invention include various operations, which will be described below. The operations, may be performed by hard-wired hardware, or may be embodied in machine-executable instructions that may be used to cause a general purpose or special purpose processor, or logic circuits programmed with the instructions to perform the operations. Alternatively, the operations may be performed by any combination of hard-wired hardware, and software driven hardware.

Embodiments of the present invention may be provided as a computer program product that may include a machine-readable medium, having instructions stored within it, which may be used to program a computer or other programmable devices to perform a series of operations according to embodiments of the invention. The machine-readable medium may include, but is not limited to, floppy diskettes, optical disks, CD-ROM's, DVD's, magno-optical disks, ROM's, RAM's, EPROM's, EEPROM's, hard drives, magnetic or optical cards, flash memory, or any other medium suitable for storing electronic instructions. Moreover, embodiments of the present invention may also be downloaded as a computer software product, wherein the software may be transferred between programmable devices by data signals in a carrier wave or other propagation medium via a communication link such as a modem or a network connection.

FIG. 3 illustrates an exemplary device 300 upon which embodiments of the invention may be implemented. For example, an article of machine-readable medium may contain instructions that, when executed, cause a machine to record a portion of a conference, and send a copy of the recorded portion of the conference to a recipient or a non-attending participant with at least one of a voicemail account and an email account. I think you need to discuss that the device may be the client or the server and walk through how the same device functions in both ways a little more clearly.

An embodiment may include an article further comprising instructions that, when executed, cause a machine to receive a response from the recipient or a non-attending participant of the recorded portion and provide it to the conference attendees. Another embodiment may include an article further comprising instructions that, when executed, cause a machine to show the status of a task the recipient or a non-attending participant received during the meeting and record follow up actions by the recipient or a non-attending participant. In an embodiment the capabilities may be hardware capabilities. In an embodiment, instructions may cause a machine to notify conference attendees when a task is completed.

In FIG. 3, device 300 comprises a bus or other communication means 301 for communicating information, and a processing means such as processor 302 coupled with bus 301 for processing information. Device 300 further comprises a random access memory (RAM) or other dynamically-generated storage device 304 referred to as main memory, coupled to bus 301 for storing information and instructions to be executed by processor 302. Main memory 304 also may be used for storing temporary variables or other intermediate information during execution of instructions by processor 302. Device 300 also comprises a read only memory (ROM) and/or other static storage device 306 coupled to bus 301 for storing static information and instructions for processor 302.

A data storage device 307 such as a magnetic disk or optical disk and its corresponding drive may also be coupled to device 300 for storing information and instructions. Device 300 can also be coupled via bus 301 to a display device 321, such as a cathode ray tube (CRT) or Liquid Crystal Display (LCD), for displaying information to an end user. Typically, an alphanumeric input device such as a keyboard 322, including alphanumeric and other keys, may be coupled to bus 301 for communicating information and/or command selections to processor 302. Another type of user input device is cursor control 323, such as a mouse, a trackball, or cursor direction keys for communicating direction information and command selections to processor 302 and for controlling cursor movement on display 321.

A communication device 325 is also coupled to bus 301. The communication device 325 may include a modem, a network interface card, or other well-known interface devices, such as those used for coupling to Ethernet, token ring, or other types of physical attachment for purposes of providing a communication link to support a local or wide area network, for example. In this manner, the device 300 may be networked with a number of clients, servers, or other information devices.

An embodiment may be an apparatus comprising a means for recording a portion of a conference, and a means for sending a copy of the recorded portion of the conference to a recipient or a non-attending participant with at least one of a voicemail account and an email account.

An embodiment may further comprise a means for receiving a response from the recipient or a non-attending participant of the recorded portion and providing it to the conference attendees. In an embodiment, the means for recording a portion of a conference may record a task the recipient or a non-attending participant received during the meeting.

An embodiment may comprise a means for showing the status of the task and recording follow up actions by the recipient or a non-attending participant. Yet another embodiment may comprise a means for integrating the task status and follow up actions by the recipient or a non-attending participant into conference software. An embodiment may further comprise a means for notifying conference attendees when a task is completed.

It is appreciated that a lesser or more equipped computer system than the example described above may be desirable for certain implementations. Therefore, the configuration of device 300 will vary from implementation to implementation depending upon numerous factors, such as price constraints, performance, requirements, technological improvements, and/or other circumstances.

Although a programmed processor, such as processor 302 may perform the operations described herein, in alternative embodiments, the operations may be fully or partially implemented by any programmable or hard coded logic, such as Field Programmable Gate Arrays (FPGAs), TTL logic, or Application Specific Integrated Circuits (ASICs), for example. Additionally, the method of the present invention may be performed by any combination of programmed general-purpose computer components and/or custom hardware components.

An embodiment may be an apparatus comprising a means for sending meeting information, such as questions regarding a meeting, to an attendee of the meeting before the meeting, a means for receiving an answer from the attendee in at least one of a voice mail format and an email format, and a means for other participants of the meeting reviewing the answer before the meeting. In an embodiment, the means for sending questions regarding a meeting may further comprise a web link with the questions, the web link to a storage to store the answer by the attendee. In an embodiment, if the answer is in voice mail format, the embodiment may further comprise a means for playing the answer to phone participant meeting attendees. Yet another embodiment may comprise a means for recording post meeting comments and making them available to at least some of the meeting participants.

Embodiments of the present invention may encompass other specific forms without departing from its spirit or essential characteristics. The described embodiments are to be considered in all respects only as illustrative instead of restrictive or limiting. Therefore, the scope of the invention is indicated by the appended claims rather than by the foregoing description. All chances, modifications, and alterations that come within the meaning, spirit, and range of equivalency of the claims are to be embraced as being within the scope of the appended claims.

1. A method comprising:
recording a portion of a conference with software, the conference having a plurality of invited participants wherein at least one of the invited participants does not attend the conference; and
sending a copy of the recorded portion of the conference with the software to at least one of a voicemail account and an email account of a non-attending participant.

2. The method of claim 1, further comprising receiving a response from the non-attending participant of the recorded portion and providing it to the conference attendees.

3. The method of claim 1, wherein the recorded portion relates to a task the non-attending participant received during the meeting.

4. The method of claim 3, further comprising showing status of the task and recording follow up actions by the non-attending participant.

5. The method of claim 4, further comprising integrating the task status and follow up actions by the non-attending participant into conference software.

6. The method of claim 4, further comprising notifying conference attendees when a task is completed.

7. A method comprising:
scheduling a meeting with software;
sending meeting information using the software to an attendee before the meeting;
receiving a comment from the attendee in at least one of a voice mail format and an email format; and
other participants of the meeting reviewing the comment before the meeting.

8. The method of claim 7, the sending meeting information further comprising a web link to a storage to store the comment by the attendee.

9. The method of claim 7, further comprising if the comment is in voice mail format, playing the comment to phone participant meeting attendees.

10. The method of claim 7, further comprising recording post meeting comments and making them available to at least some of the meeting participants.

11. An apparatus comprising:
means for scheduling a conference with software;
means for recording a portion of the conference with the software, and for sending a copy of the recorded portion of the conference to at least one recipient with at least one of a voicemail account and an email account.

12. The apparatus of claim 11, further comprising means for receiving a response from the recipient of the recorded portion and providing it to the conference attendees.

13. The apparatus of claim 11, wherein the means for recording a portion of a conference is to record a task the recipient received during the meeting.

14. The apparatus of claim 13, further comprising means for showing the status of the task and recording follow up actions by the recipient.

15. The apparatus of claim 14, further comprising means for integrating the task status and follow up actions by the recipient into conference software.

16. The apparatus of claim 14, further comprising means for notifying conference attendees when a task is completed.

17. An apparatus comprising:
means for scheduling a conference with software;
means for sending meeting information using the software to an attendee of the meeting before the meeting;
means for receiving a comment from the attendee in at least one of a voice mail format and an email format for other participants of the meeting to review.

18. The apparatus of claim 17, the means for sending meeting information further comprising a web link with the meeting information, the web link to a storage to store the comment by the attendee.

19. The method of claim 17, wherein if the comment is in voice mail format, further comprising means for playing the comment to phone participant meeting attendees.

20. The method of claim 17, further comprising means for recording post meeting comments and making them available to at least some of the meeting participants.

21. An article of machine-readable medium containing instructions that, when executed, cause a machine to:
record a portion of a conference, the conference having a plurality of invited participants; and
send a copy of the recorded portion of the conference to at least one of a voicemail account and an email account of a non-attending participant.

22. The article of claim 21, further containing instructions that, when executed, cause a machine to receive a response from the recipient of the recorded portion and provide it to the conference attendees.

23. The article of claim 21, further containing instructions that, when executed, cause a machine to show the status of a task the recipient received during the meeting and record follow up actions by the recipient.

24. The article of claim 23, further comprising instructions that, when executed, cause a machine to notify conference attendees when a task is completed.
